(19) United States
(12) Patent Application Publication
(10) Pub. No.: US 2012/0074346 A1
(43) Pub. Date: Mar. 29, 2012

(54) Corrective measures and devices for bi-stable flow phenomena in fluid valves

(75) Inventor: Daniel S. Cook, Terryville, CT (US)

(73) Assignee: Enfield Technologies, LLC

(21) Appl. No.: 13/135,351

(22) Filed: Jul. 1, 2011

Related U.S. Application Data
(60) Provisional application No. 61/361,161, filed on Jul. 2, 2010.

(51) Int. Cl. F16K 27/02

(52) U.S. Cl. 251/366

(57) ABSTRACT

In accordance with an example embodiment of the present invention, a valve is disclosed. The valve includes a valve body, a seat, a poppet, and a shaped portion. The valve body has an inlet portion and an outlet portion. The seat is between the inlet portion and the outlet portion. The poppet is proximate the seat. The poppet is adapted to modulate fluid flow between the inlet portion and the outlet portion. The shaped portion is downstream of the seat. The shaped portion is adapted to direct fluid flow, reduce cross flow interference, and allow for substantially parallel fluid flow jets at a majority of the inlet portion and the outlet portion when fluid is flowing through the valve.

### CROSS REFERENCE TO RELATED APPLICATION

This application claims priority under 35 U.S.C. §119(e) to U.S. provisional patent application No. 61/361,161 filed Jul. 2, 2010 which is hereby incorporated by reference in its entirety.

### BACKGROUND

1. Field of the Invention

The invention relates to fluid valves and, more particularly, to bi-stable flow in fluid valves.

2. Brief Description of Prior Developments

It is sometimes desirable to control the flow of compressed gases very precisely. Due to inherent limitations in sensors and control, much effort is still placed on proper mechanical design and valve geometry. In some cases, vortices can form during normal operation and can either be stable vortices or astable vortices; in any event, these vortices can often be predicted and managed by instituting geometry changes to the valve internal elements. There are other situations in which certain anomalies present themselves where prior knowledge and existing skills cannot adequately address the issue. In this particular case, an anomaly in the flow profile for a servo controlled proportional poppet valve was discovered. Conventional wisdom and design approaches were unsatisfactory in correcting the observed condition. Additionally, it is likely that this condition would go unnoticed in many other valve designs (for example as in US 2008/0185542 which is hereby incorporated by reference in its entirety) since the operating conditions and application demands required precise monotonic flow profiles from fully closed to fully open; most valves operate in either the fully open or fully closed state and only operate in an intermediate state during transitions. Another mitigating issue was the extremely low pressures coupled with the relatively high flows required; the net result in high velocities at very low pressures.

### SUMMARY

In accordance with one aspect of the invention, a valve is disclosed. The valve includes a valve body, a seat, a poppet, and a shaped portion. The valve body has an inlet portion and an outlet portion. The seat is between the inlet portion and the outlet portion. The poppet is proximate the seat. The poppet is adapted to modulate fluid flow between the inlet portion and the outlet portion. The shaped portion is downstream of the seat. The shaped portion is adapted to direct fluid flow, reduce cross flow interference, and allow for substantially parallel fluid flow jets at a majority of the inlet portion and the outlet portion when fluid is flowing through the valve.

In accordance with another aspect of the invention, a valve is disclosed. The valve includes a valve body, a seat, and a poppet. The valve body has an inlet portion and an outlet portion. The seat is between the inlet portion and the outlet portion. The poppet has a base section and an extension section. The base section is adapted to modulate fluid flow between the inlet portion and the outlet portion. The extension section extends downstream of the seat. A length of the extension section is greater than a length of the base section.

In accordance with another aspect of the invention, a valve is disclosed. The valve includes a valve body, a seat, and a poppet. The valve body has an inlet portion and an outlet portion, and a downstream section. The seat is between the inlet portion and the outlet portion. The poppet is proximate the seat. The poppet is adapted to modulate fluid flow between the inlet portion and the outlet portion. The downstream section is between the seat and an outlet of the valve. The downstream section is adapted to direct fluid flow, reduce cross flow interference, and allow for substantially parallel fluid flow jets at a majority of the inlet portion and the outlet portion when fluid is flowing through the valve.

### BRIEF DESCRIPTION OF THE DRAWINGS

The foregoing aspects and other features of the invention are explained in the following description, taken in connection with the accompanying drawings, wherein:

FIG. 1 is a cross section view of a conventional valve;

FIG. 2 is a cross section view of another conventional valve;

FIG. 3 is a cross section view of another conventional valve;

FIG. 4 is a graphical representation of valve characteristics;

FIG. 5 is graphical representation of flow versus lifting for a valve seat;

FIG. 6 is a graphical representation of valve characteristics;

FIG. 7A is a graphical representation of results from computational fluid dynamics analysis;

FIG. 7B is a graphical representation of results from computational fluid dynamics analysis;

FIG. 8A is a partial section view of a valve incorporating features of the invention;

FIG. 8B is an enlarged partial section view of valve shown in FIG. 8A;

FIG. 9A is a graphical representation of results from computational fluid dynamics analysis;

FIG. 9B is a graphical representation of results from computational fluid dynamics analysis;

FIG. 10 is a graphical representation of valve flow versus position;

FIG. 11 is a partial section view of another example valve incorporating features of the invention;

FIG. 12 is a partial section view of another example valve incorporating features of the invention;

FIG. 13 is a partial section view of another example valve incorporating features of the invention;

FIG. 14 is a partial section view of another example valve incorporating features of the invention;

FIG. 15 is another partial section view of the example valve shown in FIG. 14; and

FIG. 16 is a partial section view of another example valve incorporating features of the invention.

### DETAILED DESCRIPTION

In a typical medical respirator, high pressure gas (approximately 80 psi) is supplied to a control valve. The control valve is intended to position the valve element such that flow through the valve (and into the patient) is controlled. Since the pressure in the patients' lungs is only slightly above atmospheric, the control valve will always function with a relatively high DP that will guarantee chocked flow conditions (Pds/Pus<0.528). A new design respirator is conceived where the air source is not from a bottle of stored high pressure gas but is instead from an integrated blower/compressor. The maximum discharge pressure of this blower is intended to be only slightly above atmospheric and only as required to ensure adequate air flow into the patient. This feature allows for high portability of the equipment with lower weight and storage footprint but places great demands on the control valve beyond what would normally be expected.

Due to the low discharge pressure of the compressor and only slightly lower patient lung pressure, the control valve must function with very low differential pressures yet pass very high flows. This is usually easily achieved with a straight section of tubing or pipe; however, the valve must be able to precisely modulate flow over the entire range from about zero percent (fully closed) to about one hundred percent (fully open). With these constraints, critical flow is not achieved and the pressure/flow relationships become highly non-linear (and more prone to instability). Additionally, the application required a very subtle flow profile versus position for the first fifty percent of valve motion in order to maximize controllability at low flow conditions but achieve high flows over the final fifty percent of stroke.

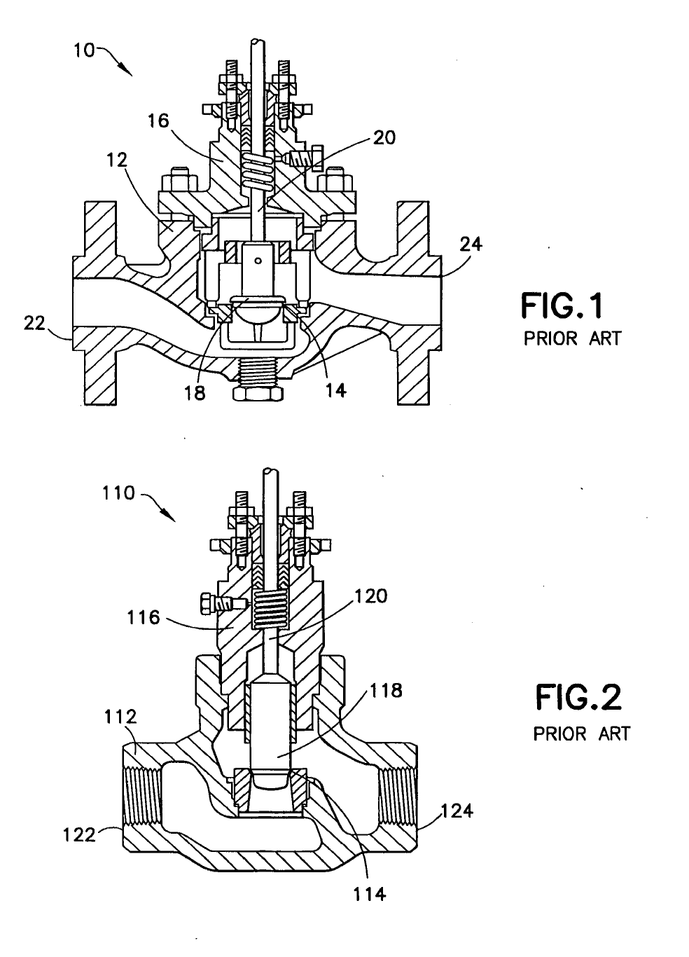

A typical poppet or globe valve 10 design is shown in FIG. 1. The valve 10 comprises a body 12, a seat 14, a bonnet 16, a disc (or poppet) 18, and a stem 20. The valve body 12 generally comprises an inlet (or inlet portion) 22 and an outlet (or outlet portion) 24. A typical poppet 18 is not intended to be operated at intermediate positions so the functional criteria are maximum flow when open and minimum leakage when closed, however, throttling capabilities are limited and often discouraged to prevent premature valve wear. A properly designed throttling or control valve 110 is shown in FIG. 2. Similar to the valve 10 described above, the valve 110 comprises a body 112, a seat 114, a bonnet 116, a disc (or poppet) 118, and a stem 120. The valve body 112 generally comprises an inlet (or inlet portion) 122 and an outlet (or outlet portion) 124. As shown in FIG. 2, the cross-sectional area allowed for flow varies as stem 120 position varies and is directly controlled by the poppet/body geometry.

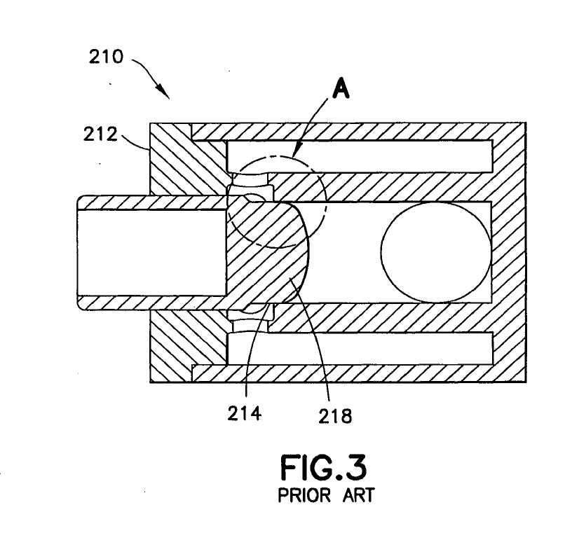

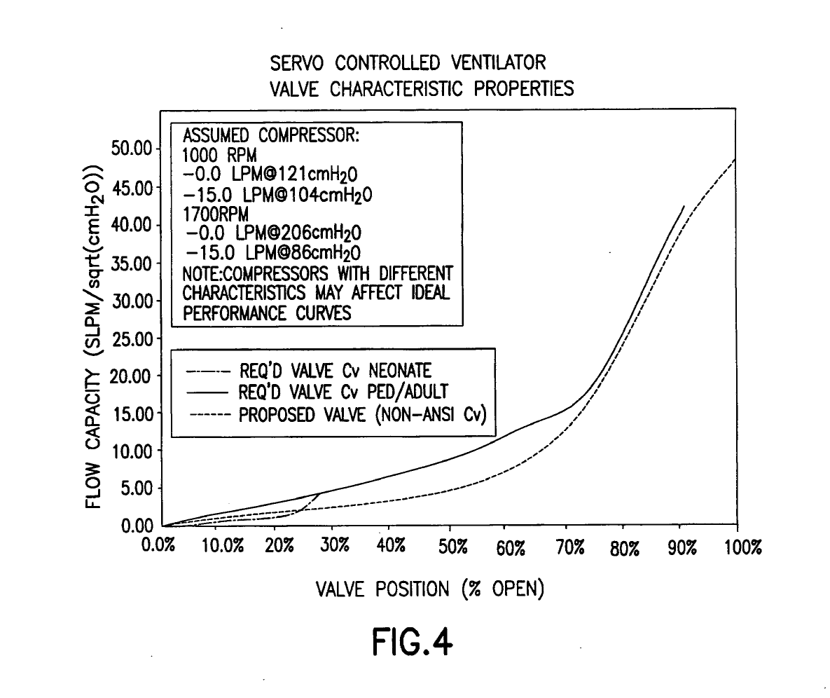

Shown in FIG. 3 is another typical poppet design. The valve 210, is similar to the valves 10, 110. For the purposes of clarity, only a portion of the valve is illustrated. For example, enlarged views of a portion of the valve body 212, the seat 214, and the disc (or poppet 218) are illustrated. As shown, one can see how the flow increases linearly as the poppet 218 opens (the cross-sectional area increases linearly with poppet position) until the valve is about fifty percent open. Once about fifty percent open, additional movement of the valve poppet 218 results in a rapidly increasing rate of flow since the cross-sectional area is increasing rapidly. The poppet profile (see area “A”) shown provides a cross-sectional area vs. poppet position relationship as shown in FIG. 4. Since area is proportional to flow for a set of pressure conditions, flow area is a good approximation of the expected flow through a component.

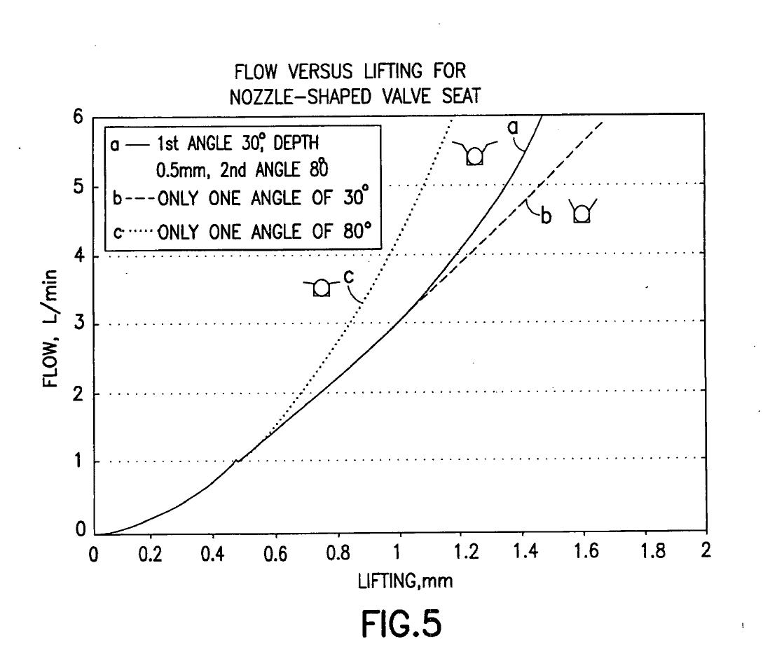

Referring to patent application US 2008/0185542 for reported test data showing similar effects on a different geometry yet no mention is made of this anomaly (anomaly is shown in FIG. 5 as an excerpt from US2008/0185542). Additionally, ABCM Article April-June 2006, Vol. XXVIII, No. 2 “Experimental Study of the Bistable Flow in Tube Arrays” discusses bi-stable flow and associated lab testing. Of particular interest is the closing paragraph “The origin of this phenomenon . . . is not completely understood”. This research was restricted to tube arrays and not directly applicable to valve geometries of interest, however, it does provide some insight into a potential root cause.

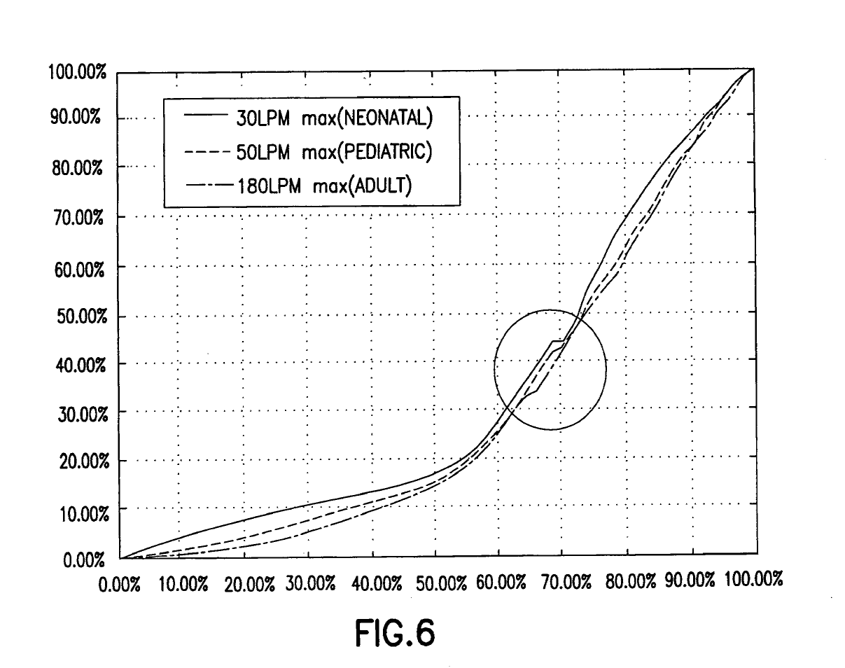

During a customized valve design effort, several prototype valves were manufactured and tested. The valve element was mechanically positioned and pressure/flow conditions monitored to verify flow characteristics against predicted. As shown in FIG. 6, measured flow tended to decrease suddenly around fifty percent valve open. Tests at other pressure conditions revealed similar results. Decreasing valve position immediately after witnessing the anomaly did not reverse the reduction in flow making it appear as though mechanical hysteresis was the cause.

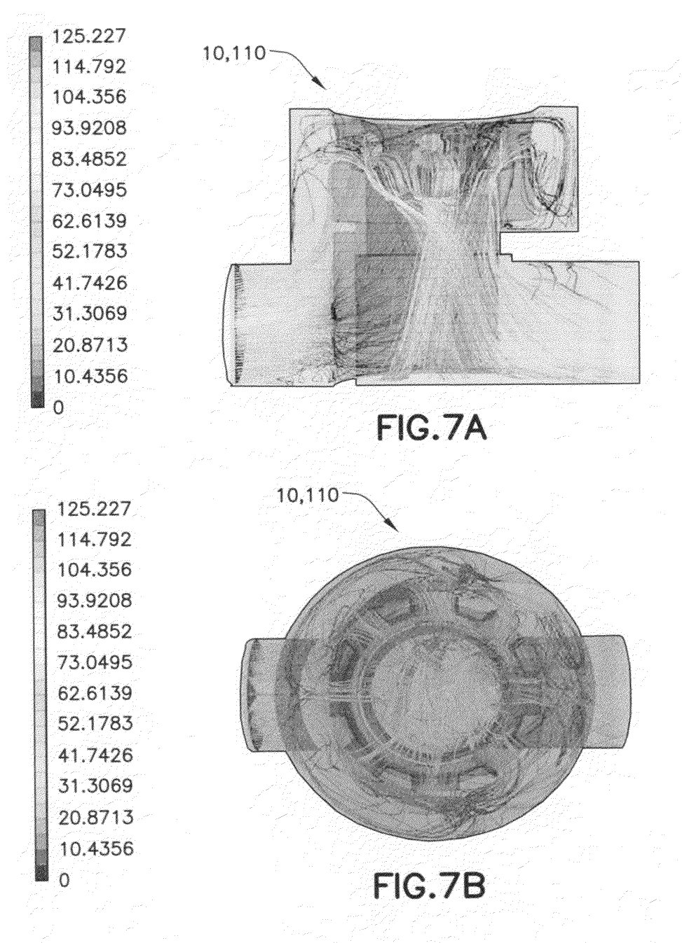

Extensive Computational Fluid Dynamics (CFD) studies using state-of-the-art fluid analysis software were conducted on computer models in an effort to identify and isolate the root cause of the anomaly. Surprisingly, the CFD software was unable to replicate the phenomenon. It is believed that since the software converges for a single set of flow conditions for every element in the FEA model, it is incapable of predicting unstable flows due to purely pneumatic phenomenon since certain approximations are made during fully developed turbulent flow models and because the analysis inherently assumes a single snap shot in time. It was noticed during analysis at certain valve positions that the solver took longer (more computational iterations) to converge and approach to convergence was more oscillatory but resolving a definitive theory from this data alone would not be wise. By examination of the output of the CFD software using graphical visualization tools it was observed at certain valve positions that flow appeared to be quite disorderly and potentially interfering with flow from the opposite side of the channel (see FIGS. 7A and 7B).

By studying the geometry and intuitively evaluating the available data, it was theorized that the rapid transition from a slowly widening area to a faster expansion toward the rounded end of the poppet resulted in a sudden trajectory change on the dominant side of the valve poppet. This trajectory change resulted in a jet of high velocity gas impinging on the opposite wall of the flow channel, restricting flow from a portion of the poppet outlet on that side.

Classical solutions including, modifying the poppet profile in the region of interest or changing pressure/flow conditions were not acceptable due to the intended application. It was surmised that downstream flow behavior modifiers. The precise nature of these elements was not immediately apparent so several design were simulated in CFD. It should be understood that CFD output only provided an ‘intuitive sense’ of the nature of the design but could not prove that the anomaly was/was not corrected for any given geometry.

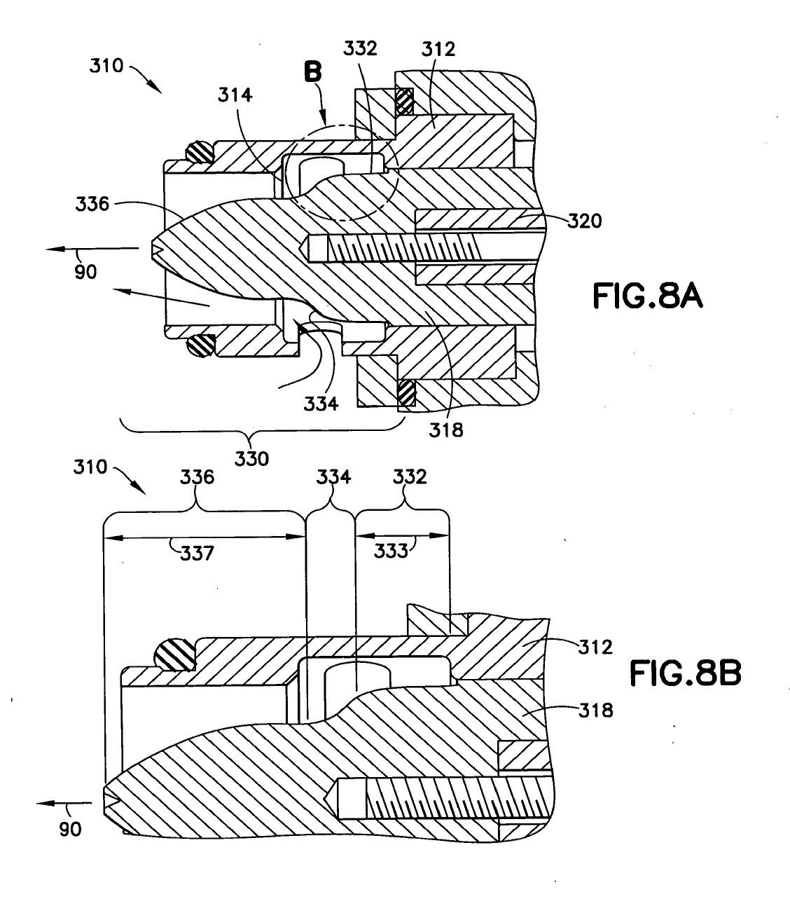

Referring to FIGS. 8, 8a, there is shown a partial section view of a valve 310 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The valve 310, is similar to the valves 10, 110, 210, however the valve 310 includes features providing for improved flow through the valve such that flow is directed advantageously and allowed to rejoin with minimal cross flow interference. For the purposes of clarity, only a portion of the valve (which may be a poppet valve or a globe valve, for example) 310 is illustrated. For example, enlarged views of a portion of a body 312, a seat 314, a disc (or poppet) 318, and a stem 320 of the valve 310 are shown. It should be noted the valve 310 can further have any suitable type of features as known in the art.

According to one example embodiment of the invention, the poppet 318 may comprise a poppet end portion (or poppet extension) 330 having a sloped section 332, a radius edge section 334, and a tip section 336. The sloped section (or base section) 332, may comprise a slope of about three degrees, for example. However, in alternate embodiments, any suitable slope dimension may be provided. The radius edge section 334 is between the tip section 336 and the sloped section 332. The tip section (or extension section) 336 may comprise a general “bullet” shape. Additionally, according to one embodiment, the poppet end portion (or shaped portion) 330 may be integrally formed with the rest of the poppet 318 as a one piece member. However, in alternate embodiments, the poppet end portion (or shaped portion) may comprise a separate member attached to an end of the poppet 318.

FIGS. 8A, 8B show one embodiment of a downstream poppet modification 330 (such as, at area “B”, for example) that prevented undesired flow instabilities or vortices while preventing cross flow trajectories and maintained approximately the desired bulk flow profile characteristics. For example, the length 337 of the extension section 336 in a direction 90 of (downstream) fluid flow is greater than a length 333 of the base section 332 in the direction 90 of (downstream) fluid flow.

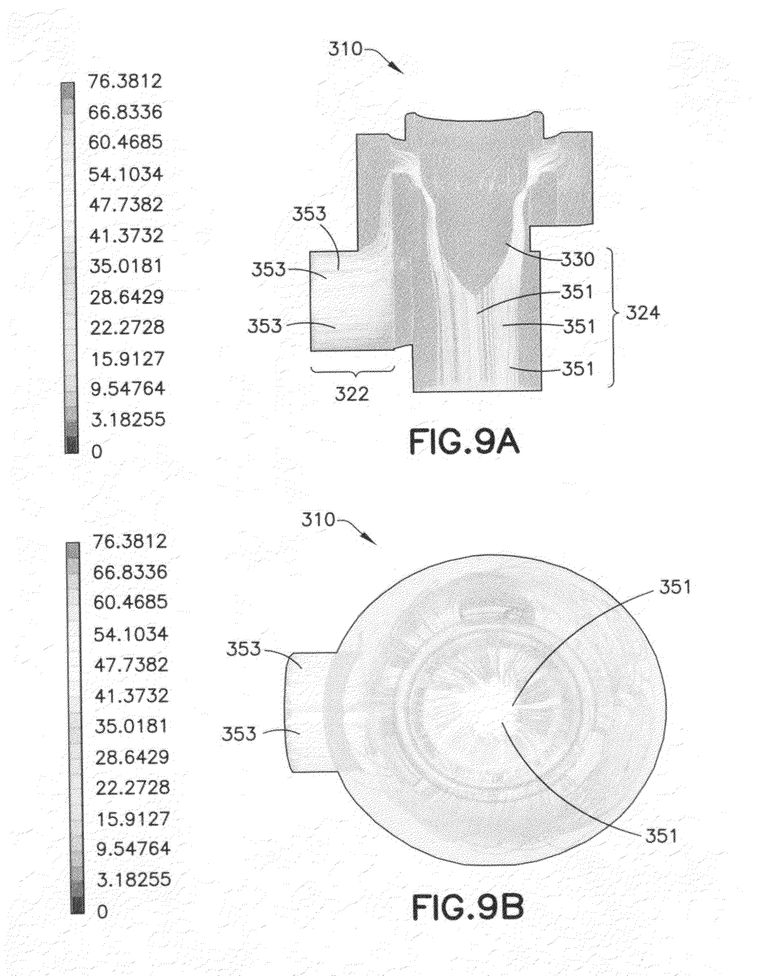

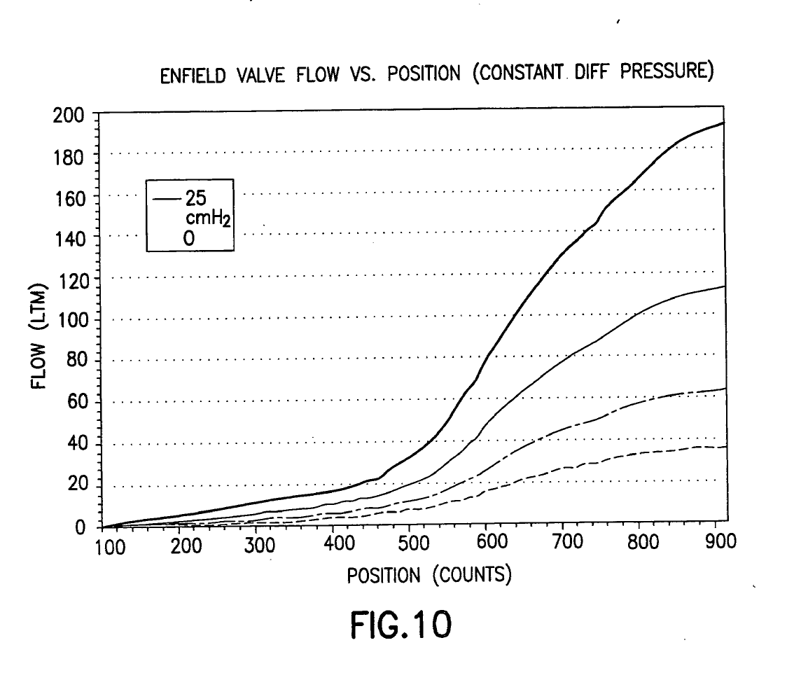

As seen in FIGS. 9A, 9B, the CFD output from the poppet extension 330 shows orderly and substantially parallel flow jets 351 (at the outlet portion 324), 353 (at the inlet portion 322) that do not interfere with other flow areas. Test prototypes incorporating the poppet extension 330 were constructed to verify the assumptions made regarding the mysterious pneumatic phenomenon and tested. The flow data shown in FIG. 10 shows that the valve performance was not degraded and the flow anomaly has been eliminated for various pressures.

While various exemplary embodiments of the invention have been described above in connection with the valve body shape and poppet shape shown in FIGS. 8A, 8B, one skilled in the art will appreciate that the invention is not necessarily so limited and that other shapes may be provided.

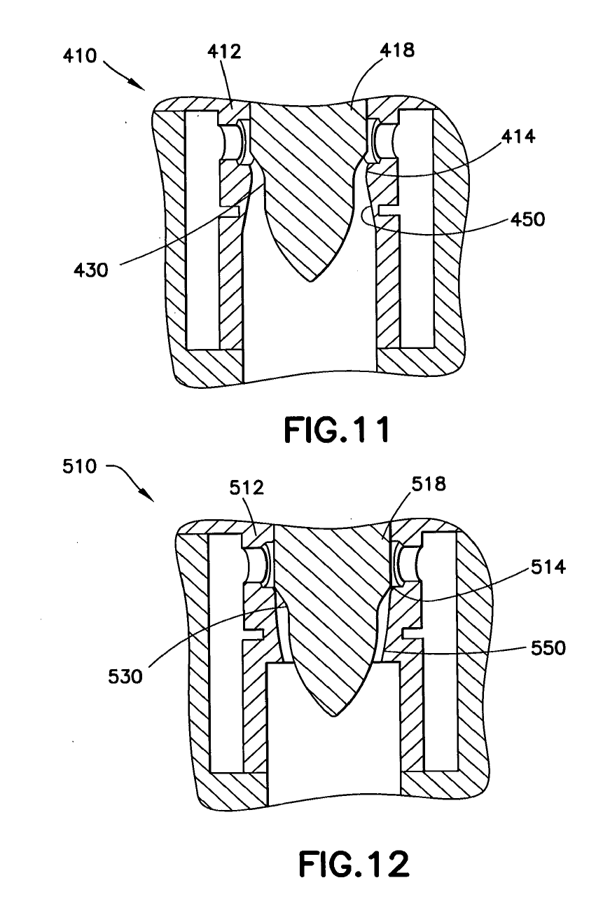

For example, and referring now also to FIG. 11, a valve 410 in accordance with another embodiment of the invention is shown. The valve 410 is similar to the valve 310 and also includes features providing for improved flow through the valve such that flow is directed advantageously and allowed to rejoin with minimal cross flow interference. For the purposes of clarity, only a portion of the valve (which may be a poppet valve or a globe valve, for example) 410 is illustrated. For example, enlarged views of a portion of the body 412, the seat 414, and the disc (or poppet) 418 are shown. In this embodiment the poppet 418 comprises a poppet extension 430 (similar to the poppet extension 330) having a general “bullet” shaped poppet tip. However, this embodiment further comprises a modification to the body 412. The body 412 comprises an expanding downstream section (or shaped portion) 450 (which may be conical, for example).

Referring now also to FIG. 12, a valve 510 in accordance with another embodiment of the invention is shown. The valve 510 is similar to the valve 310 and also includes features providing for improved flow through the valve such that flow is directed advantageously and allowed to rejoin with minimal cross flow interference. For the purposes of clarity, only a portion of the valve (which may be a poppet valve or a globe valve, for example) 510 is illustrated. For example, enlarged views of a portion of the body 512, the seat 514, and the disc (or poppet) 518 are shown. In this embodiment the poppet 518 comprises a poppet extension 530 (similar to the poppet extension 330) having a general “bullet” shaped poppet tip. However, this embodiment further comprises a modification to the body 512. The body 512 comprises a contracting downstream section (or shaped portion) 550 (which may be curvilinear, for example).

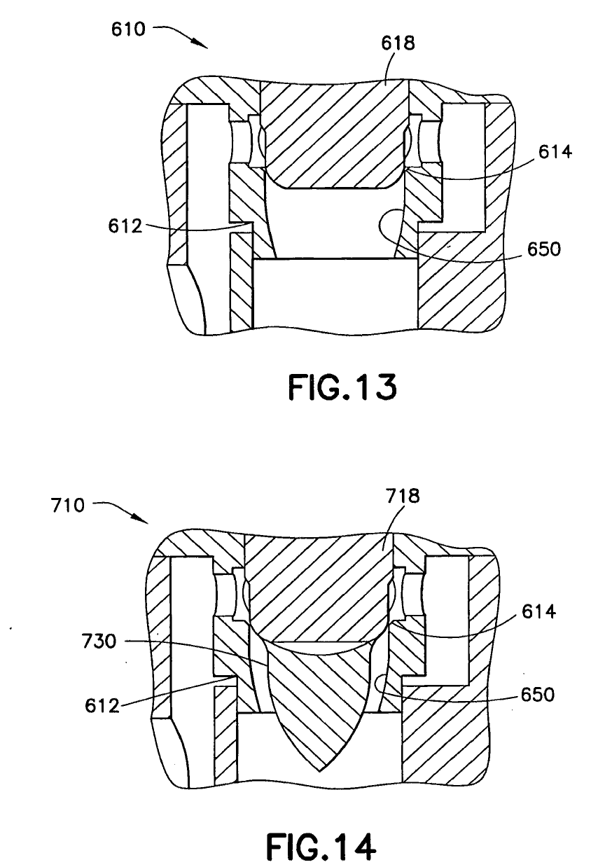

Referring now also to FIG. 13, a valve 610 in accordance with another embodiment of the invention is shown. The valve 610 is similar to the valve 310 and also includes features providing for improved flow through the valve such that flow is directed advantageously and allowed to rejoin with minimal cross flow interference. For the purposes of clarity, only a portion of the valve (which may be a poppet valve or a globe valve, for example) 610 is illustrated. For example, enlarged views of a portion of the body 612, the seat 614, and the disc (or poppet) 618 are shown. In this embodiment the poppet 618 does not comprise a poppet extension. However, this embodiment comprises a modification to the body 612. The body 612 comprises a downstream (constriction) section (or shaped portion) 650 having general torus and conical shape which creates a ‘rejoin jet’.

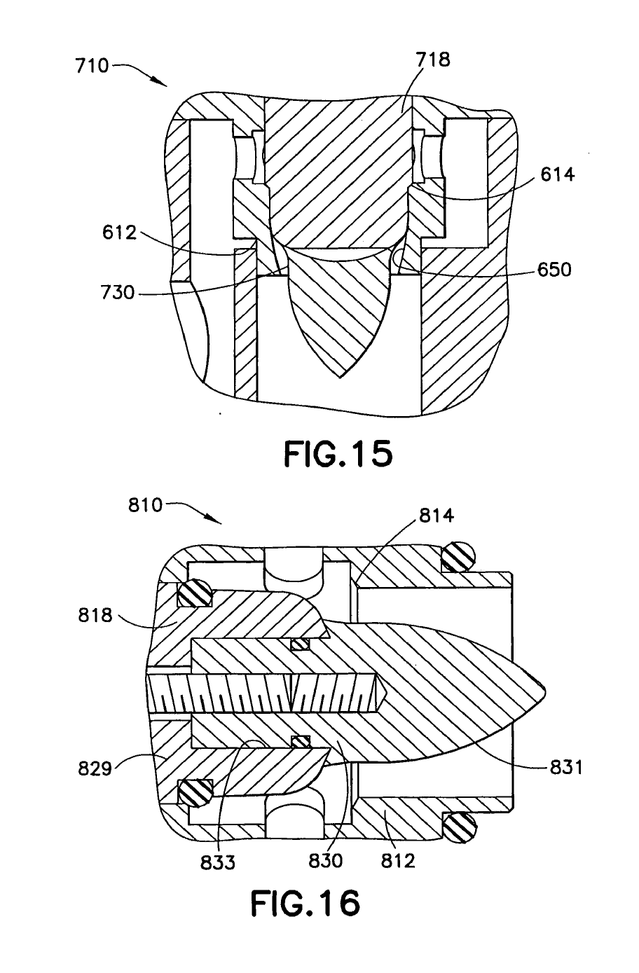

Referring now also to FIGS. 14 and 15, a valve 710 in accordance with another embodiment of the invention is shown. FIG. 14 illustrates the valve 710 in an open position, FIG. 15 illustrates the valve 710 in a closed position. The valve 710 is similar to the valve 610. The valve 710 comprises the body 612 (having the constriction section 650) and the seat 614, however in this embodiment the poppet 718 comprises a poppet extension 730 (similar to the poppet extension 330) having a general “bullet” shaped poppet tip.

Referring now also to FIG. 16, a valve 810 in accordance with another embodiment of the invention is shown. The valve 810 is similar to the valve 310 and also includes features providing for improved flow through the valve such that flow is directed advantageously and allowed to rejoin with minimal cross flow interference. For the purposes of clarity, only a portion of the valve (which may be a poppet valve or a globe valve, for example) 810 is illustrated. For example, enlarged views of a portion of the body 812, the seat 814, and the disc (or poppet) 818 are shown. In this embodiment the poppet 818 comprises a two piece assembly wherein the poppet extension 830 is removable from a poppet base section 829. The removable poppet extension 830 comprises a poppet fairing section 831 and a body section 833. The body section 833 comprises a general straight cylindrical shape. The poppet fairing section 831 extends from the body section 833 and has a general “bullet” shape. The poppet base section 829 and the removable poppet extension (or fairing tip) 830 are separate members to allow for customization of outlet flow geometry by exchanging poppet fairing tips 830 of various geometries.

It should be noted that the various valve body and/or poppet shapes described above are provided as non-limiting examples. It should further be noted that although various exemplary embodiments of the invention have been described in connection with globe valves and poppet valves, alternate embodiments may comprise any other suitable type valve or equipment.

Below are provided further descriptions of various non-limiting, exemplary embodiments. The various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, a pneumatic valve intended to be used in a servo or proportional manner comprising a modification to the end of the poppet downstream of the poppet and/or a modification to the geometry of the downstream valve body such that flow is directed advantageously and allowed to rejoin with minimal cross flow interference.

The geometry to accomplish this could take on many forms dependent on the specific application, flowing fluid, intended use, and other application specific features. Additionally, other internal geometry decisions may impact the required geometry.

The geometry should allow for at least two distinct flow regimes (low sensitivity and high sensitivity) that is accomplished by application of any portion or all portions of cones, spheres, cylinders, power function curves (x², x³, 1/x², etc), exponentials (e^{x}, k^{x}, etc), torroids, pyramid, regular solid, parallelepiped, cube, or helix. These shapes may be combined advantageously by combining (as shown above) a cylinder, a cone, a torus, another cylinder, a revolved arc.

The geometry additions could take the form as integrated part features or additional parts for add-on dependant on material requirements.

Use of these geometry changes are most advantageous in low pressure, high velocity applications but is not solely limited to these applications; these geometry alterations are likely beneficial in higher pressures or vacuum (particularly vacuum) where velocities in excess of Ma=0.1 is expected or the fluid compressibility and inertia are significant.

It should be understood that components of the invention can be operationally coupled or connected and that any number or combination of intervening elements can exist (including no intervening elements). The connections can be direct or indirect and additionally there can merely be a functional relationship between components.

Below are provided further descriptions of various non-limiting, exemplary embodiments. Various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

In one exemplary embodiment, a valve comprising a valve body having an inlet portion and an outlet portion, a seat between the inlet portion and the outlet portion, a poppet proximate the seat, wherein the poppet is adapted to modulate fluid flow between the inlet portion and the outlet portion, and a shaped portion downstream of the seat, wherein the shaped portion is adapted to direct fluid flow, reduce cross flow interference, and allow for substantially parallel fluid flow jets at a majority of the inlet portion and the outlet portion when fluid is flowing through the valve.

A valve as above, wherein the poppet comprises a poppet end portion, and wherein the poppet end portion comprises the shaped portion.

A valve as above, wherein the poppet end portion is integrally formed with the poppet.

A valve as above, wherein the poppet end portion is a separate member configured to be removable from the poppet.

A valve as above, wherein the valve body comprises the shaped portion.

A valve as above, wherein the shaped portion comprises a constriction section having a general torus and conical shape.

A valve as above, wherein the shaped portion comprises a general bullet shape.

A valve as above, wherein the shaped portion is adapted to allow for at least two distinct flow regimes.

A valve as above, wherein the shaped portion comprises a general cylinder shape, a general cone shape, a general torus shape, and/or a general revolved arc shape.

In another exemplary embodiment, a valve comprising a valve body having an inlet portion and an outlet portion, a seat between the inlet portion and the outlet portion, a poppet having a base section and an extension section, wherein the base section is adapted to modulate fluid flow between the inlet portion and the outlet portion, wherein the extension section extends downstream of the seat, and wherein a length of the extension section is greater than a length of the base section.

A valve as above, wherein the wherein a length of the extension section in a direction of fluid flow is greater than a length of the base section in the direction of fluid flow.

A valve as above, wherein the extension section is adapted to direct fluid flow, reduce cross flow interference, and allow for substantially parallel fluid flow jets at a majority of the inlet portion and the outlet portion when fluid is flowing through the valve.

A valve as above, wherein the extension section comprises a general bullet shape.

A valve as above, wherein the valve body comprises a shaped portion downstream of the seat.

A valve as above, wherein the extension section comprises a general cylinder shape, a general cone shape, a general torus shape, and/or a general revolved arc shape.

In another exemplary embodiment, a valve comprising a valve body having an inlet portion and an outlet portion, and a downstream section, a seat between the inlet portion and the outlet portion, a poppet proximate the seat, wherein the poppet is adapted to modulate fluid flow between the inlet portion and the outlet portion, wherein the downstream section is between the seat and an outlet of the valve, and wherein the downstream section is adapted to direct fluid flow, reduce cross flow interference, and allow for substantially parallel fluid flow jets at a majority of the inlet portion and the outlet portion when fluid is flowing through the valve.

A valve as above, wherein the downstream section comprises a general torus and conical shape.

A valve as above, wherein the downstream section comprises an expanding section having a general conical shape.

A valve as above, wherein the downstream section comprises a contracting section having a general curvilinear shape.

A valve as above, wherein the poppet further comprises a shaped portion downstream of the seat, wherein the shaped portion is adapted to direct fluid flow, reduce cross flow interference, and allow for substantially parallel fluid flow jets at a majority of the inlet portion and the outlet portion when fluid is flowing through the valve.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A valve comprising:
a valve body having an inlet portion and an outlet portion;
a seat between the inlet portion and the outlet portion;
a poppet proximate the seat, wherein the poppet is adapted to modulate fluid flow between the inlet portion and the outlet portion; and
a shaped portion downstream of the seat, wherein the shaped portion is adapted to direct fluid flow, reduce cross flow interference, and allow for substantially parallel fluid flow jets at a majority of the inlet portion and the outlet portion when fluid is flowing through the valve.

2. A valve as in claim 1 wherein the poppet comprises a poppet end portion, and wherein the poppet end portion comprises the shaped portion.

3. A valve as in claim 2 wherein the poppet end portion is integrally formed with the poppet.

4. A valve as in claim 2 wherein the poppet end portion is a separate member configured to be removable from the poppet.

5. A valve as in claim 1 wherein the valve body comprises the shaped portion.

6. A valve as in claim 5 wherein the shaped portion comprises a constriction section having a general torus and conical shape.

7. A valve as in claim 1 wherein the shaped portion comprises a general bullet shape.

8. A valve as in claim 1 wherein the shaped portion is adapted to allow for at least two distinct flow regimes.

9. A valve as in claim 1 wherein the shaped portion comprises a general cylinder shape, a general cone shape, a general torus shape, and/or a general revolved arc shape.

10. A valve comprising:
a valve body having an inlet portion and an outlet portion;
a seat between the inlet portion and the outlet portion;
a poppet having a base section and an extension section, wherein the base section is adapted to modulate fluid flow between the inlet portion and the outlet portion, wherein the extension section extends downstream of the seat, and wherein a length of the extension section is greater than a length of the base section.

11. A valve as in claim 10 wherein the wherein a length of the extension section in a direction of fluid flow is greater than a length of the base section in the direction of fluid flow.

12. A valve as in claim 10 wherein the extension section is adapted to direct fluid flow, reduce cross flow interference, and allow for substantially parallel fluid flow jets at a majority of the inlet portion and the outlet portion when fluid is flowing through the valve.

13. A valve as in claim 10 wherein the extension section comprises a general bullet shape.

14. A valve as in claim 10 wherein the valve body comprises a shaped portion downstream of the seat.

15. A valve as in claim 10 wherein the extension section comprises a general cylinder shape, a general cone shape, a general torus shape, and/or a general revolved arc shape.

16. A valve comprising:
a valve body having an inlet portion and an outlet portion, and a downstream section;
a seat between the inlet portion and the outlet portion;
a poppet proximate the seat, wherein the poppet is adapted to modulate fluid flow between the inlet portion and the outlet portion;
wherein the downstream section is between the seat and an outlet of the valve, and wherein the downstream section is adapted to direct fluid flow, reduce cross flow interference, and allow for substantially parallel fluid flow jets at a majority of the inlet portion and the outlet portion when fluid is flowing through the valve.

17. A valve as in claim 16 wherein the downstream section comprises a general torus and conical shape.

18. A valve as in claim 16 wherein the downstream section comprises an expanding section having a general conical shape.

19. A valve as in claim 16 wherein the downstream section comprises a contracting section having a general curvilinear shape.

20. A valve as in claim 16 wherein the poppet further comprises a shaped portion downstream of the seat, wherein the shaped portion is adapted to direct fluid flow, reduce cross flow interference, and allow for substantially parallel fluid flow jets at a majority of the inlet portion and the outlet portion when fluid is flowing through the valve.
